(19) United States
(12) Patent Application Publication
(10) Pub. No.: US 2026/0360965 A1
(43) Pub. Date: Nov. 12, 2026

(54) Device for Attaching an Electronic Component to a Tire Casing

(71) Applicant: COMPAGNIE GENERALE DES ETABLISSEMENTS MICHELIN, Clermont-Ferrand (FR)

(72) Inventor: Loic BERLIOUX, Clermont-Ferrand Cedex 9 (FR)

(21) Appl. No.: 19/137,908

(22) PCT Filed: Nov. 20, 2023
(86) PCT No.: PCT/EP2023/082394

§ 371 Date: Jun. 11, 2025

(30) Foreign Application Priority Data
Dec. 14, 2022 (FR) FR2213309

(51) Int. Cl. H01Q 1/22; B60C 23/04

(52) U.S. Cl. CPC H01Q 1/2241; B60C 23/0452

(57) ABSTRACT

An electronic system having a member (10) and a retaining device (510), where the retaining device has a base (511), a retaining wall extending from the base as far as an edge and defining an open volume that accommodates the member. The volume has an opening delimited by the edge. The member has a housing circumscribed inside a cylinder having an axis of revolution. Wherein the radial extension of the wall (512) from a closed line (530) as far as the edge (513) ranges between 25% and 35% of the radial distance (r530) of the line (530), the housing (12) has a cliff (50), and the cliff (50) extends along the axis of revolution (15) over a distance greater than the thickness of the wall (512).

### FIELD OF THE INVENTION

The present invention relates to devices for securing an electronic member to a tire casing with the aim of conveying identification information regarding the tire casing or physical parameters of the tire casing that are measured by the electronic member over the course of the life of the tire casing.

### TECHNOLOGICAL BACKGROUND

The development of electronic objects in tire casings makes it possible to make tire casings connectable and connected, and this stimulates the development of new services in order to optimize the use of the tire casing, for example. Now, these electronic members sometimes have thermomechanically fragile components, and this requires the electronic member to be inserted after manufacture of the tire casing. Thus, the insertion of a securing device as interface between the electronic member and the tire has emerged. These securing devices are generally elastic so as not to highly stress the tire casing, so as to follow the substantial deformations undergone by the tire casing over the course of its use and so as to damp the stresses transmitted to the electronic member. One of the most commonly used designs for the device is a patch having a base used for securing to the tire casing and provided with a wall that is closed on itself and extends from the base as far as an opening. The wall serves to hold or keep the electronic member in position within the device, the electronic member being mounted tightly inside the wall that deforms elastically. The opening allows the insertion and extraction of the electronic member into and from the patch by virtue of the elasticity of the material of the opening.

Document WO2018/150141A1 illustrates a patch of this nature. Although this patch specifically has a clamping system in order to limit the opening, it is in all respects in accordance with a patch for securing an electronic object to a tire casing. In addition, this type of patch sometimes presents a problem of mechanical strength of the system comprising the patch and the electronic member over the course of the use of the tire casing to which this system is secured. Under high running speed conditions in particular, the forces generated on the patch and on the electronic member as a result of the change in radius of curvature at the moment at which that sector of the tire casing to which the patch is secured enters or leaves the contact patch are high. This sometimes leads to the securing patch being deformed to such an extent that the electronic member mounted inside the patch comes at least partially out of its accommodating cavity in the patch, this ultimately leading to the electronic member being ejected from the patch. This ejection of the electronic member, which is generally destructive to the electronic member, may also damage the very structure of the tire casing as a result of the electronic member being thrown against the walls of the tire, notably at high speed.

The aim of the following subjects of the invention is to solve the problems of ejection of the electronic member of the securing patch in a way that simultaneously is economical and reliable and does not adversely affect the operation of the electronic member accommodated within the securing patch.

### DESCRIPTION OF THE INVENTION

The invention relates to an electronic system comprising an electronic member and a retaining device for retaining the electronic member and able to be secured to a wall of a tire casing, said retaining device comprising:
a base that is able to be secured to the wall of the tire casing via an external surface,
a closed retaining wall, which is able to retain said electronic member, extending from the base as far as a free edge and defining, with said base, an open volume;
said volume, which is able to accommodate at least a part of said electronic member, being defined by an internal surface of said base and by an internal surface of said retaining wall, having an opening delimited by the free edge of said retaining wall, which is able to deform for the insertion of said electronic member into said volume;
   said electronic member comprising a protective housing defining an outer surface circumscribed inside a cylinder of which the axis of revolution is perpendicular to the median plane of the external surface of the base of said retaining device and which is delimited by two parallel planes; and characterized in that the free edge of the retaining wall extends radially towards the axis of revolution of the cylinder circumscribing the outer surface of the protective housing from a closed line of the distal retaining wall of the base about the axis of revolution, the points of which have a tangent vector which has a main component along the radial direction of the cylindrical frame of reference associated with the cylinder, in that the radial extension of the retaining wall as far as each point of the free edge extends over a distance of between 25% and 35% of the radial distance of the closed line in the same radial plane, in that the outer surface of the protective housing comprises a first cliff radially on the inside of the projection of the free edge of the retaining wall onto the outer surface along the direction of the axis of revolution, in that a part of the first cliff is tangential, over an angular sector, to the projection of the free edge onto the outer surface and in that the first cliff, having its main component along the direction of the axis of revolution, extends along the direction of the axis of revolution over a distance greater than twice the thickness of the retaining wall at the free edge along that said direction.

Such a securing device makes it possible to address the technical problem stated, since the dimension of the radial extension is controlled and that provides a certain degree of bending, and as a result the deformation of the opening of the patch can be managed in a way that means the electronic member cannot be ejected easily from the securing device. In addition, the size of the radial extension also controls the dimension of the opening delimited by the free edge, thereby forcing the electronic member to remain inside the open volume. The presence and the size of the cliff on the protective housing of the electronic member also limits the deformation of the retaining wall, thereby forcing the electronic member to remain inside the open volume of the securing device. However, the electronic member can still be extracted using an external tool that enlarges the opening of the retaining wall beforehand by applying a uniform specific load to the entirety of the free edge in order to reduce the radial extension of the retaining wall. During use of the tire and even at high speed, such a force cannot be applied to the system because the tool is not present in the tire and because the specific nature of the external force applied to the system at the moment of impact as the angular sector of the tire to which the electronic system is secured enters the contact patch is unable to be uniform over the entirety of the free edge of the retaining wall.

Advantageously, the first cliff is tangential to the projection of the free edge of the retaining wall onto the outer surface along the axis of revolution over at least one third of the entire curvilinear length of the projection of the free edge onto the outer surface.

Very advantageously, the first cliff is tangential to the projection of the free edge of the retaining wall onto the outer surface along the axis of revolution over at least half of the entire curvilinear length of the projection of the free edge onto the outer surface.

With preference, the first cliff is tangential to the projection of the free edge of the retaining wall onto the outer surface along the axis of revolution over the entire curvilinear length of the projection of the free edge onto the outer surface.

Making the first cliff of the protective housing of the electronic member and the free edge of the retaining wall touch over at least one third of the curvilinear length of the free edge limits the movement of the electronic member with respect to the securing device because contact is established immediately or with a delay depending on the imposed relative movement of the two objects. One third of the curvilinear length represents, for a continuous and closed free edge, an angular sector of at least 120 degrees. Even if the relative movement of the two objects does not directly cause the first cliff and the free edge to come into contact, this contact will occur over a wide range of relative movements of the two objects. When this contact occurs, a contact force is generated and opposes this movement, thereby contributing to retaining the electronic member within the cavity of the securing device. When the region of contact between the first cliff and the free edge of the retaining wall becomes angularly greater to the point of becoming complete, this increases the amplitude and degree of retention of the electronic member within the open volume of the securing device.

In one specific embodiment, the electronic member comprises the following elements:
a radio transmitter/receiver coupled to at least one radio antenna;
a microprocessor situated on a printed circuit, coupled to the radio transmitter/receiver and powered by an energy source, said elements being encapsulated in the protective housing.

The electronic member in this case comprises a radiofrequency transponder, i.e. comprises radiofrequency communications components able to transmit/receive so as to pick up a command and respond to this command. Here, the radiofrequency transponder is active, which is to say that it comprises an energy source that it uses chiefly for emitting the response by radiofrequency communication. This is because radiofrequency transmission is a functionality that consumes energy for large-content responses such as transmitting measurement or calculation data. For the calculation functionality, the microprocessor has fairly sophisticated calculation capability in order to process the measurement data coming from a measurement sensor for example connected to the microprocessor. It should be noted that the energy source, which may for example be a battery, may be not only bulky but also heavy, leading to significant centrifugal forces and impact forces that are not insignificant if the electronic member is accidentally ejected from the securing device.

The invention also relates to an arrangement of an electronic system and of a tire casing able to rotate about an axis of rotation, said tire casing comprising a crown (S), two sidewalls (F) extending from the crown (S) and terminating in two beads (B) that are able to be connected to a wheel, wherein the electronic system is secured by means of the external surface of the base of the retaining device to one of the surfaces of the tire casing, preferably to the radially inner surface of the tire casing.

Advantageously, the electronic system is secured to the radially inner surface of the tire casing in line with the crown (S) of the tire casing.

This arrangement is the final destination of the electronic system that forms the first subject of the invention. Because the electronic system comprises an electronic member, this electronic member cannot be fitted to the tire casing at the green tire stage. This is because the electronic member would be unable to withstand the thermal and mechanical stresses associated with the method for manufacturing a tire casing. It is usually preferable to install the electronic system after the tire has been manufactured. As a result, this electronic system is positioned on one of the surfaces, which are by nature exterior surfaces, of the tire casing. As a preference, the electronic system is positioned on the radially interior surface of the tire casing in line with respect to the natural axis of rotation of the tire casing. Thus, the electronic member is protected, in conditions of use on a tire casing, by the rubbery structure of the tire casing, which improves the mechanical endurance of the electronic member. Positioning it in line with the crown makes it possible to have easy access to measured characteristics measured by means of a sensor of the electronic member that is associated with the contact patch, thereby enabling tire-use characteristics, such as the applied static load, the running speed, to be fed back.

With preference, with the tire casing being able to rotate about the axis of rotation in a main direction corresponding to a direction of travel, with respect to the ground, of a vehicle equipped with said arrangement travelling forwards, the centre of mass of the points of the first cliff of the protective housing of the electronic member that are tangential to the projection of the free edge of the retaining wall onto the outer surface is positioned behind the axis of revolution of the cylinder circumscribing the protective housing of the electronic member in the direction of travel of the vehicle when the electronic system is entirely in an angular sector of the tire casing that is in contact with the ground.

In instances in which the tire is being used for forward travel, which may be at very high running speeds, positioning that part of the first cliff of the protective housing that is tangential to the free edge of the retaining wall with respect to the axis of revolution of the cylinder circumscribing the protective housing ensures that contact between the free edge and the first cliff will occur immediately on entering the contact patch. As a result, the reaction force exerted by this contact will oppose the ejection of the electronic member from the retaining device. This is particularly true in instances in which the tangency between the two elements the first cliff and the free edge-does not cover the entirety of the curvilinear length of the free edge. Thus, the orientation of the electronic system in the tire casing when this system is positioned in line with the crown (S) of the tire casing is a factor that influences the non-ejection of the electronic member, particularly at very high speed. Running on a vehicle at high speed and very high speed occurs when the vehicle is in a forward gear travelling forwards.

What is meant here by the expression “behind” is that the two points are spaced by a distance d in said direction and that this distance d may be zero.

Very preferably, the median plane of that part of the first cliff that is tangential to the projection of the free edge of the retaining wall onto the outer surface that delineates the angular sector of the part of the first cliff into two equal angular sectors in the cylindrical frame of reference associated with the cylinder circumscribing the protective housing of the member has a normal with a main component along the axis of rotation of the tire casing, this normal preferably being co-linear with the axis of rotation of the tire casing.

In order to ensure that the technical solution envisaged for retaining the electronic member in the securing device is effective in all types of condition of use on the vehicle, particularly when the tire casing is mounted on a wheel of the steered axle of the vehicle, it is preferable for that part of the first cliff that is tangential to the free edge to be angularly centred in such a way that contact is achieved equally well in a straight line as when cornering to the right or when cornering to the left.

### BRIEF DESCRIPTION OF THE DRAWINGS

The invention will be better understood upon reading the following description, given solely by way of non-limiting example and with reference to the appended figures, throughout which the same reference numerals denote identical parts, and in which:

FIG. 1 depicts a perspective view of an electronic member able to be secured to a tire via a retaining device, from the prior art;

FIG. 2 depicts a view in section on the radial plane of the electronic system according to one embodiment of the invention;

FIG. 3 depicts a view from above, namely from the same side as the opening of the cavity of the retaining device, of the electronic system for the same embodiment of the invention;

FIG. 4 depicts a perspective view, in cross section, of a tire casing equipped with an electronic system according to the invention.

### DETAILED DESCRIPTION OF EMBODIMENTS

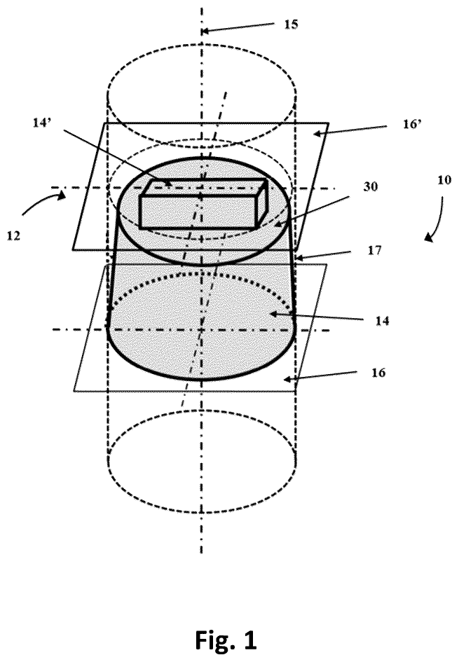

FIG. 1 is a perspective view of an electronic member 10 able to be secured to a tire casing using a retaining device, of the prior art.

The electronic member 10, depicted here in grey, is delimited by a protective housing 12 encapsulating all of the electronic components of the electronic member 10. This protective housing 12 has an exterior surface 30 circumscribed by a cylinder 17 having an axis of revolution 15 which is perpendicular to the printed circuit of the electronic member 10. This cylinder 17, which has an axis of revolution 15, is truncated by two parallel planes 16 and 16′ which rest respectively on the axially exterior surfaces 14 and 14′ of the protective housing 12.

This protective housing 12 takes the form of a combination of a cone and of a parallelepiped. The conical shape makes it easier to insert into or extract from a retaining device. On one of its axially exterior surfaces, the cone has a parallelpiped that houses the radio antenna. The latter is encapsulated in the protective housing 12. The protective housing 12 is a monolithic part or a part assembled from a number of component parts, the component parts then being welded together.

The component parts or the monolithic part are obtained for example using a moulding method from a plastics material such as a thermoset. Low-temperature curing of the plastic completes the production of the exterior surface 30 of the protective housing 12.

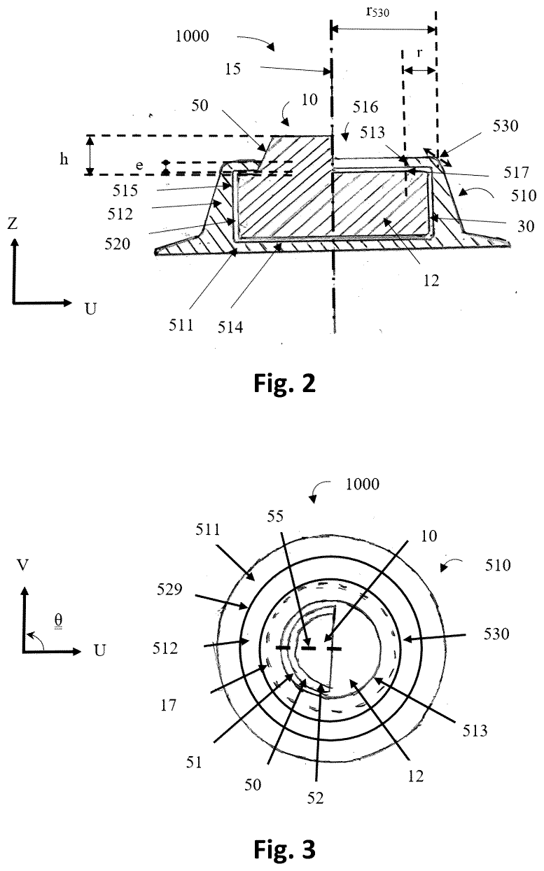

FIG. 2 is a view in section on the radial plane of an electronic system 1000 according to one embodiment of the invention.

The electronic system 1000 is made up of an electronic member 10 and of a retaining device 510 which is intended to be secured to the wall of a tire casing.

The retaining device 510 comprises a base 511 able to be secured to the wall of a tire casing via an external surface and a closed retaining wall 512, the purpose of which is to retain said electronic member 10. The retaining wall 512 extends from the base 511 as far as a free edge 513 and thus defines, with the base 511, a volume 520. This volume 520 is open, thus allowing the electronic member 10 to be inserted into and extracted from the volume 520. The volume 520 is delimited by the internal surface 515 of the retaining wall 512 and the internal surface 514 of the base 511. The opening 516 of the volume 520 is delimited by the free edge 513 of the retaining wall 512. This opening 516 is able to deform to allow the electronic member 10 to be inserted into and extracted from the volume 520.

As in FIG. 1, the electronic member 10 comprises a protective housing 12 encapsulating all of the electronic components. This protective housing 12 defines an external surface 30. This external surface 30 is circumscribed inside a cylinder of which the axis of revolution 15 is perpendicular to the median plane of the external surface of the base 511. The circumscribing cylinder is truncated by two parallel planes the first of which belongs to the internal surface 514 of the base 511 and the second plane is situated axially to the outside of the opening 516 of the retaining device 510.

The retaining wall 512 extends axially from the base 511 as far as the free edge 513. That part of the retaining wall 512 that comprises the free edge 513 has an extension that is predominantly radial rather than axial so as to constitute a retaining lip for retaining the electronic member 10. One of the ends of the lip is the free edge 513. The other end 530 is a closed line, the points of which have a vector which is tangent to the closed line and has a predominant component along the radial direction with respect to the axis of revolution 15. The radial extension of the lip thus formed extends from the closed line 530 as far as the free edge 513 over a distance r of between 25% and 35% of the radial distance r530 of the closed line 530 from the axis of revolution 15. The radial length of the lip contributes to retaining the electronic member 10 within the retaining device in the event of running at high speeds when the system 1000 is secured to the wall of a tire casing. However, this radial length is associated with another feature of the electronic system to fully ensure this retaining function.

Specifically, the protective housing 12 in this case has a cliff 50 extending to the outside of the volume 520 of the retaining device 510. This cliff 50 has its main component extending along the direction of the axis of revolution 15. The axial extension “h” of the cliff is greater than twice the thickness “e” of the retaining wall 512 at the free edge 513. This condition on the distance of the axial extension of the cliff 50 guarantees the positioning of the electronic member 10 with respect to the opening 516 of the retaining device, thereby ensuring better retention of the electronic member 10 within the retaining device 510. In addition, this cliff 50 needs to be situated partly in the immediate vicinity of the free edge 513 of the lip defined by the retaining wall 512. It is consequently necessary to ensure that the projection 517 of the free edge 513 in the axial direction 15 onto the external surface 30 of the protective housing is tangential to the cliff 50 of the electronic member. Thus, the positioning of the electronic member 10 within the retaining device 510 is even more constrained at least in terms of movement in a direction perpendicular to the line of tangency in an axial plane. Finally, in order to increase the directions of potential immobilization, the tangency between the cliff 50 and the projection 517 of the free edge 513 onto the external surface 30 should occur over an angular sector about the axis of revolution 15. Here, tangency is assured over 180 degrees, thereby constraining the relative movement of the electronic member 10 within the retaining device 510 over half of the possible movements. For applications to tires of a steered axle, a sector of 120 degrees is desirable in order to prevent situations under cornering with a potentially optimized positioning of the electronic system 1000 within the tire.

The combination of the presence of the cliff 50 on the external surface 30 of the electronic member 10 and of the size of the lip defined by the retaining wall ensures that there will be no accidental ejection of the electronic member 10 from the retaining device 510 during normal use at high speeds when the electronic system 1000 is installed on a tire of a motor vehicle.

FIG. 3 is a view from above of the electronic system 1000 of FIG. 2. What that means to say is that from outside the electronic system 1000, the latter is observed, in the axial direction, from the same side as the opening of the volume of the retaining device 510.

Starting from the radial periphery of the electronic system 1000, what can be seen first of all is the axially outer edge of the base 511, which in this case is circular, although the outer edge of the base 511 could also be elliptical or quadrilateral. What can be seen next is a first circle 529 which corresponds to the separation between the base 511 and the retaining wall 512 and which is characterized by a change in curvature, and the material points on this circle 529 have a tangent of which the main component is axial. What can be seen next is a circle 530 corresponding to the closed line of the retaining wall 512 which represents one end of the annular lip of the retaining wall 512. This lip ends at a second circle 513 which represents the free edge of the retaining wall 512. Next, between the circles 530 and 513 there is a first circle 17 in dotted line which corresponds to the radially outer surface of the circle circumscribing the external surface of the protective housing 12 of the electronic member 10.

Through the opening delimited by the circle 513, here there may be seen two semicircles 51 and 52 which correspond to the axial ends of the cliff 50 of the protective housing 12 of the electronic member 10. Thus, this cliff 50 is predominantly, but not solely, axial. The circle 51 is tangential to the circle 513 over the entirety of its semicircle, thus sweeping an angular sector of 180 degrees about the axis of rotation of the circumscribing cylinder 17 at the external surface of the protective housing 12. Here, the angular sector is divided into two angular sectors of 90 degrees each by the median plane 55 of which the normal is co-linear with the vector V. As an aid to understanding, this view from above is defined in an axial plane (U, V) of which the normal corresponds to the axis of revolution of the circumscribing cylinder 17. Once the electronic system 1000 has been secured to the wall of the tire casing, the local vector U of the electronic system of FIG. 3 should preferably correspond to the director vector of the circumferential direction of the cylindrical frame of reference associated with the tire about its natural axis of rotation. Thus, once mounted on the vehicle, that part of the cliff 50 that is tangential to the free edge 513 of the retaining wall is situated behind the axis of revolution 15 of the electronic system 1000 when the tire is running along a roadway with the vehicle in a forward gear for travelling forwards. This then ensures more effective retention of the electronic member 10 within the retaining device 510.

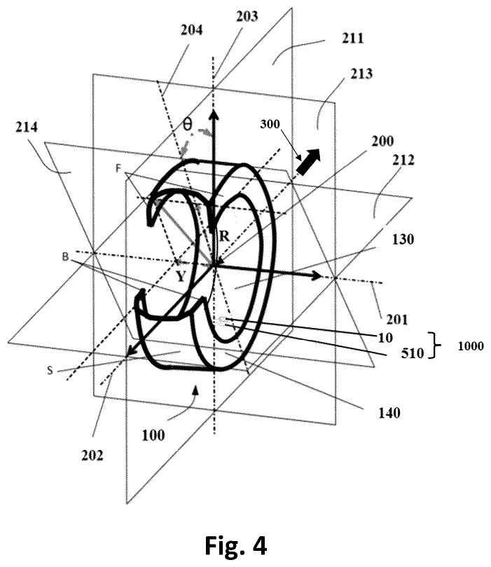

FIG. 4 shows a cross section of a pneumatic tire 100, which is also a tire casing, according to the invention, comprising a crown S extended by two sidewalls F and terminating in two beads B. In this case, the tire 100 is intended to be mounted on a wheel that is not shown in this figure, at the two beads B. This delimits a closed cavity containing at least one pressurized fluid, the cavity being delimited both by the second, radially inner surface 130 of the pneumatic tire 100 and by the external surface of the wheel. The pneumatic tire 100 also comprises a first, radially external surface 140 of the pneumatic tire 100.

The axis corresponding to the reference axis or natural axis of rotation of the pneumatic tire 100, and the median plane 211, which is perpendicular to the reference axis 201 and equidistant from the two beads B, will be denoted the reference axis 201. The intersection of the reference axis 201 with the median plane 211 determines the centre of the pneumatic tire 200. A Cartesian frame of reference will be defined at the centre of the pneumatic tire 200, constituted of the reference axis 201, a vertical axis 203 perpendicular to the ground and a longitudinal axis 202 perpendicular to the other two axes. Furthermore, the plane that passes through the reference axis 201 and the longitudinal axis 202, parallel to the plane of the ground and perpendicular to the median plane 211, will be defined as the axial plane 212. Finally, the plane perpendicular to both the median plane 211 and the axial plane 212, passing through the vertical axis 203, will be termed the vertical plane 213.

Any material point of the pneumatic tire 100 is uniquely defined by its cylindrical coordinates (Y, R, θ). The scalar Y represents the axial distance to the centre of the pneumatic tire 200 in the direction of the reference axis 201, defined by the orthogonal projection of the material point of the tire 100 onto the reference axis 201. A plane making an angle θ with respect to the vertical plane 213 around the reference axis 201 will be defined as a radial plane 214. The material point of the pneumatic tire 100 is referenced in this radial plane 214 by the distance R to the centre of the pneumatic tire 200 in the direction perpendicular to the reference axis 201, identified by the orthogonal projection of this material point onto the radial axis 204. The unit vector perpendicular to the radial plane 214, which forms a direct trihedron with the unit vectors of the axial direction 201 and radial direction 204, represents the circumferential direction of the tire casing 100. It will be noted that FIG. 4 includes an arrow 300 which is assigned to the longitudinal axis 202 and indicates the direction of travel of the tire 100 when it is mounted on the vehicle and the vehicle is travelling forwards.

This tire 100 has, on the radially inner surface 130, a retaining device 510 that is secured to the surface 130 by adhesive bonding according to the usual prior-art techniques when the retaining device 510 is made of elastomer material. The retaining device 510 is secured in line with the crown S of the tire casing 100, and this improves its endurance since the retaining device 510 thus positioned invites less concern during the operations of mounting the tire casing 100 on the wheel or removing it therefrom. Specifically, the retaining device 510 is situated in a region distant from the beads B of the tire casing 100. In this case, the retaining device 510 is equipped with an electronic member 10 within its open volume that constitutes a housing designed to receive the electronic member 10. As a result, the tire casing 100 is in this case ready to be mounted on a wheel so as to constitute a wheel-tire assembly. The electronic member 10 may deliver various functions, such as identifying certain components like the electronic member itself, the tire. However, the electronic member may also be equipped with a pressure and/or temperature sensor in order to evaluate the inflation pressure of the wheel-tire assembly. Lastly, it may also be equipped with a sensor directly measuring the curvature of the tire casing, such as an accelerometer or a flexometer, making it possible to derive usual variables of the tire such as the angular speed, the distance covered and the static load applied. All of these variables make it possible to identify performance qualities of the tire casing such as for example its wear, its grip or intrinsic variables of the ground on which the tire casing is running.

In the specific case of FIG. 4, the electronic components of the electronic member 10 are encapsulated in a protective housing. This protective housing has a cliff which extends above the retaining device 510. Here, the cliff is tangential to the free edge of the retaining wall of the retaining device 510 in its entirety. The free edge delimits the opening of the retaining device 510 via which the electronic member 10 is inserted into or extracted from the accommodating volume of the retaining device 510. In this particular case, the centre of mass of the points of the line of tangency between the cliff of the electronic member 10 and the free edge of the retaining device 510 is situated on the axis of revolution of the electronic member 10, and this corresponds to a particular case in which that part of the cliff that is tangential to the free edge is situated behind the axis of revolution of the electronic member.

1. An electronic system comprising an electronic member and a retaining device for retaining the electronic member and able to be secured to a wall of the tire casing, said retaining device comprising:
a base that is able to be secured to the wall of the tire casing via an external surface,
a closed retaining wall, which is able to retain said electronic member, extending from the base as far as a free edge and defining, with said base, an open volume;
said volume, which is able to accommodate at least a part of said electronic member, being defined by an internal surface of said base and by an internal surface of said retaining wall, and having an opening, delimited by the free edge of said retaining wall, which is able to deform for the insertion of said electronic member into said volume;
said electronic member comprising a protective housing defining an outer surface circumscribed inside a cylinder of which the axis of revolution is perpendicular to the median plane of the external surface of the base of said retaining device and which is delimited by two parallel planes; and
wherein the free edge of the retaining wall extends radially towards the axis of revolution of the cylinder circumscribing the outer surface of the protective housing from a closed line of the distal retaining wall of the base about the axis of revolution, the points of which have a tangent vector which has a main component along the radial direction of the cylindrical frame of reference associated with the cylinder (17), wherein the radial extension of the retaining wall as far as each point of the free edge extends over a distance (r) of between 25% and 35% of the radial distance (r₅₃₀) of the closed line in the same radial plane, wherein the outer surface of the protective housing comprises a first cliff radially on the inside of the projection of the free edge of the retaining wall onto the outer surface along the direction of the axis of revolution, and wherein a part of the first cliff is tangential, over an angular sector, to the projection of the free edge onto the outer surface and in that the first cliff, having its main component along the direction of the axis of revolution, extends along the direction of the axis of revolution over a distance (h) greater than twice the thickness (e) of the retaining wall at the free edge along that said direction.

2. The electronic system according to claim 1, wherein the first cliff is tangential to the projection of the free edge of the retaining wall onto the outer surface along the axis of revolution over at least one third of the entire curvilinear length of the projection of the free edge onto the outer surface.

3. The electronic system according to claim 2, wherein the first cliff is tangential to the projection of the free edge of the retaining wall onto the outer surface along the axis of revolution over at least half of the entire curvilinear length of the projection of the free edge onto the outer surface.

4. The electronic system according to claim 3, wherein the first cliff is tangential to the projection of the free edge of the retaining wall onto the outer surface along the axis of revolution over the entire curvilinear length of the projection of the free edge onto the outer surface.

5. The electronic system according to claim 1, wherein the electronic member comprises the following elements:
a radio transmitter/receiver coupled to at least one radio antenna;
a microprocessor situated on a printed circuit, coupled to the radio transmitter/receiver and powered by an energy source,
said elements being encapsulated in the protective housing.

6. An arrangement of an electronic system according to claim 1 and of a tire casing able to rotate about an axis of rotation, said tire casing comprising a crown (S), two sidewalls (F) extending from the crown (S) and terminating in two beads (B) that are able to be connected to a wheel, wherein the electronic system is secured by means of the external surface of the base of the retaining device to one of the surfaces of the tire casing tire.

7. The arrangement according to claim 6, wherein the electronic system is secured to the radially inner surface of the tire casing in line with the crown (S) of the tire casing.

8. The arrangement according to claim 7, wherein, with the tire casing being able to rotate about the axis of rotation in a main direction corresponding to a direction of travel, with respect to the ground, of a vehicle equipped with said arrangement travelling forwards, the centre of mass of the points of the first cliff of the protective housing of the electronic member that are tangential to the projection of the free edge of the retaining wall onto the outer surface is positioned behind the axis of revolution of the cylinder circumscribing the protective housing of the electronic member in the direction of travel of the vehicle when the electronic system is entirely in an angular sector of the tire casing that is in contact with the ground.

9. The arrangement according to claim 8, wherein the median plane of that part of the first cliff that is tangential to the projection of the free edge of the retaining wall onto the outer surface that delineates the angular sector of the part of the first cliff into two equal angular sectors in the cylindrical frame of reference associated with the cylinder circumscribing the protective housing of the electronic member has a normal with a main component along the axis of rotation of the tire casing tire.

10. The arrangement according to claim 6, wherein the electronic system is secured by means of the external surface of the base of the retaining device to the radially inner surface of the tire casing.

11. The arrangement according to claim 9, wherein the normal is co-linear with the axis of rotation of the tire casing.
